(19) United States
(12) Patent Application Publication
(10) Pub. No.: US 2025/0263228 A1
(43) Pub. Date: Aug. 21, 2025

(54) WASTE COLLECTION BAG

(71) Applicant: Esther Kim, San Gabriel, CA (US)

(72) Inventor: Esther Kim, San Gabriel, CA (US)

(21) Appl. No.: 19/054,686

(22) Filed: Feb. 14, 2025

Related U.S. Application Data
(60) Provisional application No. 63/554,990, filed on Feb. 17, 2024.

(51) Int. Cl. B65F 1/14; B31B 70/81; B31B 70/86; B31B 170/10; B65F 1/00; E01H 1/12

(52) U.S. Cl. CPC B65F 1/14; B31B 70/8134; B31B 70/872; B65F 1/002; E01H 1/1206; B31B 2170/10; B65F 2240/136; B65F 2250/105; B65F 2250/1143; B65F 2250/1146; B65F 2250/116; E01H 2001/124

(57) ABSTRACT

Disclosed are example embodiments of a waste collection bag. The waste collection bag includes a body with an opening at one end. The waste collection bag also includes a plurality of compartments formed within said body. Each compartment is sized and shaped to receive a user's finger(s), thereby defining separate finger areas within the bag to facilitate gripping and manipulation of the bag. The compartments are formed by a sealed area extending partway up from a closed edge opposite the opening.

### CROSS-REFERENCE TO RELATED APPLICATIONS

This present application claims priority to U.S. Provisional Patent Application No. 63/554,990, filed Feb. 17, 2024, the disclosure of which is incorporated herein by reference in its entirety.

### TECHNICAL FIELD

The disclosure relates generally to the field of waste collection devices, and specifically and not by way of limitation; some embodiments are related to a bag designed for the sanitary collection and disposal of pet waste.

### BACKGROUND

The collection and disposal of pet waste, for example, dog feces, presents a significant issue for pet owners and communities. It's not just about cleanliness but also environmental health. Traditional approaches to managing pet waste involve tools and methods like plastic bags, scoopers, or other instruments designed for waste collection. These are the most accessible and widely used methods due to their simplicity and direct approach to solving the problem.

Plastic bags are commonly used because they are readily available, inexpensive, and may be easily carried and disposed of. Pet owners typically use them to pick up waste during walks, which helps to maintain the cleanliness of public spaces such as parks, sidewalks, and community areas. However, traditional dog waste bags often present challenges in grip and maneuverability, making picking up after pets less efficient and more cumbersome for the user.

On the other hand, Scoopers offer a more hands-off approach to waste collection, allowing pet owners to pick up waste without directly touching it. They can be particularly useful for individuals who are squeamish about the task or for collecting waste from multiple pets at once. Scoopers can be made from various materials, including metal and plastic, and some are designed with features like long handles for ease of use and less bending over. Despite the utility of these methods, scoopers come with their own challenges, especially in terms of grip and efficiency in different environmental conditions. For instance, scoopers might not work as effectively as bags on uneven surfaces or in grassy areas where waste can be more challenging to pick up cleanly.

In light of these limitations, there is a need for more innovative solutions for pet waste disposal.

### SUMMARY

In one example implementation, an embodiment includes a waste collection bag and its manufacturing methods designed to improve the efficiency and hygiene of pet waste management. The innovative bag features multiple finger compartments for enhanced grip and control, created by sealed areas within the bag's body.

Disclosed are example embodiments of a waste collection bag. The waste collection bag includes a body having an opening at one end. The waste collection bag also includes a plurality of compartments formed within said body, each compartment being sized and shaped to receive a user's finger, thereby defining separate finger areas within the bag to facilitate gripping and manipulation of the bag. The compartments are formed by a sealed area extending partway up from a closed edge opposite of the opening.

Disclosed are example embodiments of a method of manufacturing a waste collection bag. The method includes forming a bag body with an open end and a closed end. The method also includes creating at least two sealed areas within the bag body extending partway up from a closed edge opposite of the opening to form at least two separate compartments within the bag for receiving fingers.

The features and advantages described in the specification are not all-inclusive. In particular, many additional features and advantages will be apparent to one of ordinary skill in the art in view of the drawings, specification, and claims. Moreover, it should be noted that the language used in the specification has been principally selected for readability and instructional purposes and may not have been selected to delineate or circumscribe the disclosed subject matter.

### BRIEF DESCRIPTION OF THE DRAWINGS

The foregoing summary, as well as the following detailed description, is better understood when read in conjunction with the accompanying drawings. The accompanying drawings, which are incorporated herein and form part of the specification, illustrate a plurality of embodiments and, together with the description, further serve to explain the principles involved and to enable a person skilled in the relevant art(s) to make and use the disclosed technologies.

FIGS. 1A-1B are diagrams illustrating main views of flat bags in accordance with some embodiments of the waste collection bags of the instant application.

FIGS. 2A-2B are diagrams illustrating the main views of the flat bags with example measurements in accordance with embodiments of the waste collection bags of the instant application.

FIGS. 3A-3B are diagrams illustrating side views of the flat bags in accordance with some embodiments of the waste collection bags of the instant application.

FIGS. 4A-4B are diagrams illustrating top views of the flat bags in accordance with some embodiments of the waste collection bag of the instant application.

FIGS. 5A-5B are diagrams illustrating bottom views of the flat bags in accordance with some embodiments of the waste collection bag of the instant application.

FIGS. 6A-6B are diagrams illustrating dorsal views of the flat bags in accordance with some embodiments of the waste collection bags of the instant application.

FIGS. 7A-7B are diagrams illustrating main views of bags with one side drawstring in accordance with some embodiments of the waste collection bags of the instant application.

FIGS. 8A-8B are diagrams illustrating the main views of the bags with one side drawstring with example measurements in accordance with some embodiments of the waste collection bag of the instant application.

FIGS. 9A-9B are diagrams illustrating side views of the bags with one side drawstring in accordance with some embodiments of the waste collection bag of the instant application.

FIGS. 10A-10B are diagrams illustrating top views of the bags with one side drawstring in accordance with some embodiments of the waste collection bag of the instant application.

FIGS. 11A-11B are diagrams illustrating bottom views of the bags with one side drawstring in accordance with some embodiments of the waste collection bag of the instant application.

FIGS. 12A-12B are diagrams illustrating dorsal views of the bags with one side drawstring in accordance with some embodiments of the waste collection bag of the instant application.

FIGS. 13A-13B are diagrams illustrating main views of bags with two side drawstrings in accordance with some embodiments of the waste collection bags of the instant application.

FIGS. 14A-14B are diagrams illustrating the main views of the bags with two side drawstrings with example measurements in accordance with some embodiments of the waste collection bag of the instant application.

FIGS. 15A-15B are diagrams illustrating a side views of the bags with two side drawstrings in accordance with some embodiments of the waste collection bag of the instant application.

FIGS. 16A-16B are diagrams illustrating top views of the bags with two side drawstrings in accordance with some embodiments of the waste collection bag of the instant application.

FIGS. 17A-17B are diagrams illustrating bottom views of the bags with two side drawstrings in accordance with some embodiments of the waste collection bags of the instant application.

FIGS. 18A-18B are diagrams illustrating dorsal views of the bags with two side drawstrings in accordance with some embodiments of the waste collection bag of the instant application.

FIG. 19 is a flow diagram illustrating an example method of manufacturing a waste collection bag, in accordance with the systems and methods described herein.

The figures and the following description describe certain embodiments by way of illustration only. One skilled in the art will readily recognize from the following description that alternative embodiments of the structures and methods illustrated herein may be employed without departing from the principles described herein. Reference will now be made in detail to several embodiments, examples of which are illustrated in the accompanying figures. It is noted that wherever practicable, similar or similar reference numbers may be used in the figures to indicate similar or similar functionality.

### DETAILED DESCRIPTION

In the ongoing quest to enhance the practicality and sanitation of pet waste management, this disclosure presents innovative embodiments of a waste collection bag and its manufacturing method. These embodiments introduce a sophisticated design that significantly improves user experience in pet waste collection. The waste collection bag, characterized by its unique structure, includes a body with an opening at one end and, more notably, features a plurality of internal compartments. Each compartment may be sized and shaped to accommodate a user's fingers, creating distinct finger areas within the bag (e.g., one embodiment may have one central partition to create two compartments. The user may place two fingers in each compartment.). This arrangement may facilitate an improved grip and manipulation of the bag, making waste collection more efficient and hygienic. As described herein, the compartments may be formed by sealed areas that extend partway up from a closed edge opposite the bag's opening.

Additionally, this disclosure outlines a method for manufacturing such a waste collection bag, emphasizing creating at least two sealed areas within the bag body. These areas may form separate compartments central to the bag's enhanced functionality. Some embodiments may address these issues by introducing a plastic bag design incorporating multiple finger compartments. This design may enhance the user's grip and control when picking up dog waste, providing a more sanitary and efficient means of disposal.

In some embodiments, the bag can be constructed from a variety of materials, catering to different preferences for durability, biodegradability, and tactile feel. Possible materials include but are not limited to, traditional plastics (e.g., polyethylene, polypropylene, or any other suitable plastic material) for durability and moisture resistance, biodegradable plastics (e.g., polylactic acid (PLA), polyhydroxyalkanoates (PHAs)) for environmentally conscious consumers, offering the same utility while ensuring the bag breaks down in a reasonable timeframe, compostable materials (e.g., corn starch-based compounds) that decompose in composting conditions, further reducing environmental impact, or recycled materials to support sustainability efforts, utilizing post-consumer or post-industrial plastics in the manufacturing process.

In one embodiment, an innovation lies in the bag's design, featuring a sealed area part way up from one edge, e.g., perpendicular to the edge, to create two or more separate finger compartments. It will be understood that some embodiments may have more than two compartments. For example, three compartments may be formed, four compartments may be formed, e.g., one for each finger, five compartments may be formed, e.g., one for each finger and one for the thumb. A thumb compartment may be formed off a side at right angles to the other compartments. It will be further understood that even more compartments may be formed to allow users flexibility in finger/thumb placement, e.g., to the middle or to one side, for example. In some aspects, this design may offer several benefits.

One aspect may have an improved grip. The separate finger compartments may allow users to insert one or more of their fingers into individual sections, enhancing grip and control over the bag. This finger placement may be beneficial in adverse conditions, such as wet or slippery surfaces, ensuring a secure waste collection.

One aspect may provide for enhanced sanitation. By providing a better way to pick up waste, the design may minimize the user's contact with the waste, improving the sanitary conditions of the task.

One aspect may provide for adaptability. The finger compartments may accommodate various hand sizes, with the potential for multiple sizes of bags to cater to a broader audience of users, e.g., a wide variety of hand sizes.

One aspect may provide ease of use. The design may simplify the process of waste collection, making the process of waste collection more efficient and less unpleasant for the user. The distinct finger compartments also aid in opening the bag, reducing the time and effort needed to prepare the bag for use.

In addition to the previously described materials and structural design, some embodiments may be further characterized by sealing mechanisms designed to secure the bag's contents after use. These mechanisms may ensure that the waste can be contained until it can be appropriately disposed of, thereby enhancing the sanitary benefits of some embodiments.

Some embodiments may include a drawstring closure system. The drawstring may be integrated around the opening perimeter of the bag, allowing users to close and seal the bag quickly after collecting the pet waste. This feature may provide a secure seal to prevent spillage and contain odors effectively. In some aspects, the drawstring may also allow the bag to be closed and re-opened to add additional pet waste.

The drawstring may also facilitate the bag's carrying to a disposal point, as the drawstring can be tightened and knotted, creating a handle. Including a drawstring may enhance the utility and convenience of the bag, making it an all-in-one solution for pet waste collection and disposal.

Another embodiment features two handles located at the top sides of the bag. These handles may be pulled apart to open the bag quickly and provide a means to carry the bag once the waste is collected.

Additionally, the handles may be designed to be tied together to seal the bag securely. This method of sealing may be particularly user-friendly, as this method of sealing may allow for a simple and effective closure without the need for additional sealing mechanisms. For example, the handles may be reinforced to ensure that the handles withstand the weight of the bag's contents without tearing, providing a robust solution for transporting pet waste.

The finger compartments, drawstring, handles, or some combination of these may be designed to work in concert to provide an optimal user experience. For example, the finger compartments may allow for precise control and sanitary pick-up of waste, while the drawstring and handles may offer convenient sealing and carrying options.

The bag's design may also consider ease of manufacturing, which may ensure that adding drawstring and handles does not significantly complicate the production process. This consideration may help keep the waste bag affordable while maximizing the waste bag's utility and user-friendliness.

Referring now to the figures, multiple embodiments will be discussed.

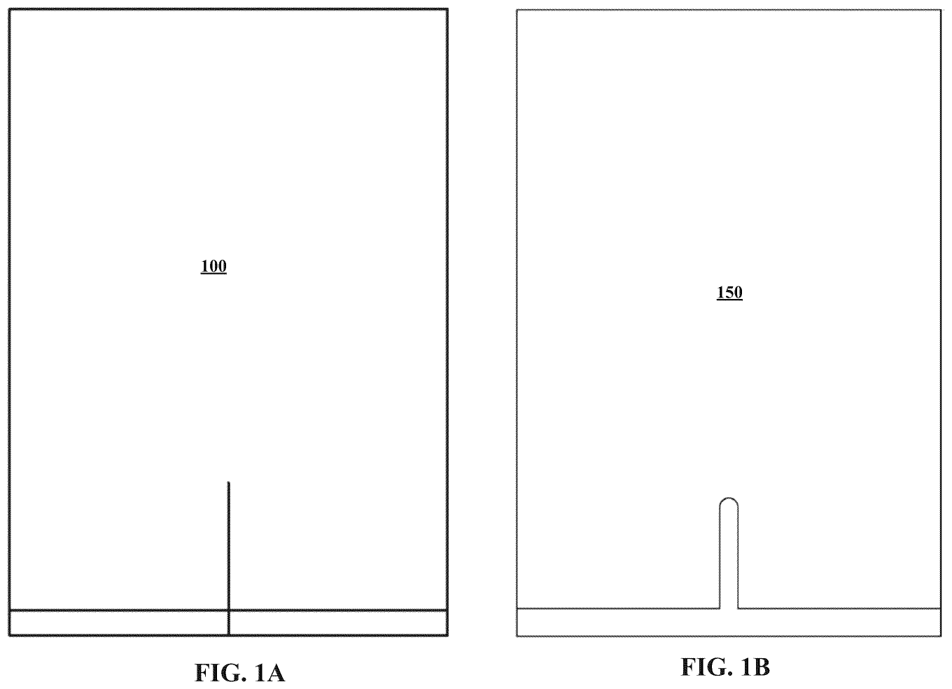

### FIGS. 1A-1B to 6A-1B: Embodiment with No Drawstring

FIGS. 1A-1B are diagrams illustrating main views of flat bags 100, 150 in accordance with some example embodiments of the waste collection bags of the instant application. These figures illustrates the design of the flat waste collection bag, highlighting the waste bag's body with an opening at one end and the innovative feature of multiple internal compartments for finger placement, aiming to improve grip and manipulation during waste collection.

The waste collection bags, featuring an innovative structure, may be designed specifically for pet waste management. The illustrated waste bags have a main body with an opening at one end for waste collection. The internal compartments may be designed to accommodate each finger separately and set these waste collection bags apart, enhancing the user's ability to grip and manipulate the bags precisely. These finger compartments are created by sealed areas that extend partway up from the bag's closed edge opposite the opening. This design focuses solely on improving the handling and control during waste collection, offering a simple, practical approach to maintaining hygiene and efficiency in pet waste disposal. The design of bag 100 features a central line in the middle of the bag. In contrast, the design of bag 150 may be stronger and less prone to tearing. Bag 150 may incorporate a U-shaped structure that redistributes tension when stretched, significantly enhancing durability and resistance to tearing.

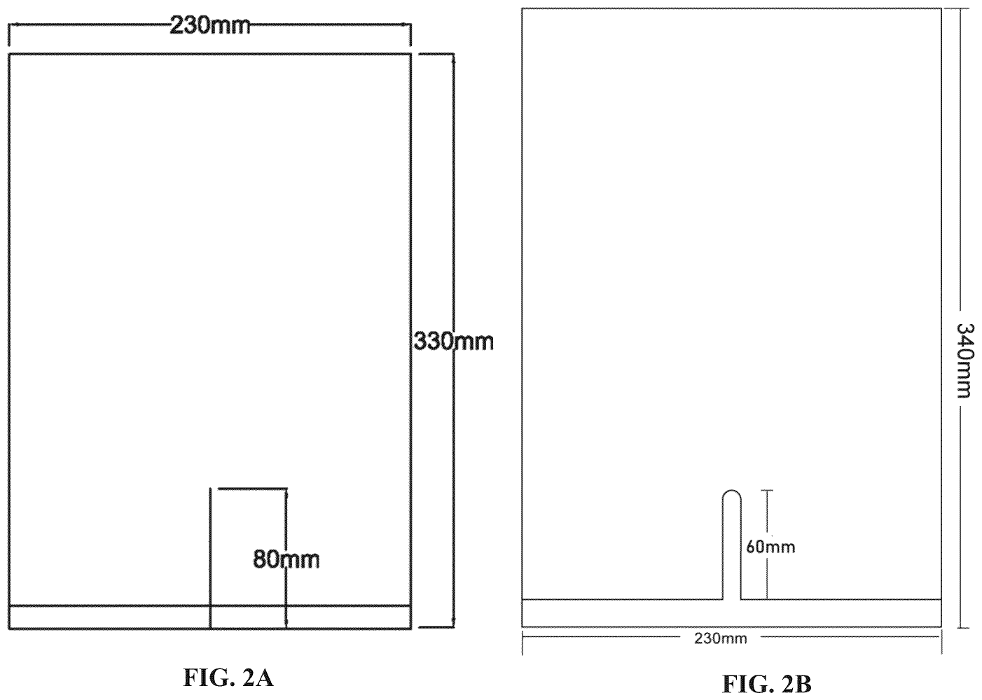

FIGS. 2A-2B are diagrams illustrating main views of the flat bags with example measurements in accordance with some example embodiments of the waste collection bags of the instant application. It provides detailed dimensions of an example waste bag, offering a quantitative understanding of one example waste bag's size and how the waste bags may be designed to accommodate various hand sizes, enhancing user experience in pet waste collection.

More specifically, the diagrams of FIGS. 2A-2B presents detailed views of flat waste collection bags, complete with example measurements that exemplify one specific size configuration within the broader range of the waste collection bags designs. This depiction illustrates not just a singular, fixed design, but rather illustrates the versatility and adaptability of the waste bag concept to meet diverse user needs. The provided measurements serve as a reference point, emphasizing that the design can be tailored to accommodate hands of various sizes, thereby enhancing the usability and accessibility of the bags for a wide demographic of users.

Recognizing that hand sizes vary significantly across individuals, the design's adaptability is a feature that may allow for the creation of multiple versions of the bag, each differing in dimensions. This flexibility ensures that users can find a bag that comfortably fits their hand, enabling efficient and hygienic waste collection without compromising on ease of use or control. By offering a variety of sizes, the design may cater to the ergonomic needs of different users, ensuring that the act of pet waste collection is as comfortable and effective as possible for everyone, or at least many different users.

This approach underscores the thoughtful consideration behind the waste bag's design, aiming not only to improve pet waste management practices but also to do so in a manner that is inclusive and considerate of the diverse needs of the user base. The diagram, with its example measurements, thus represents just one possibility within a comprehensive range of sizes designed to bring efficiency, hygiene, and comfort to the task of pet waste collection for all users.

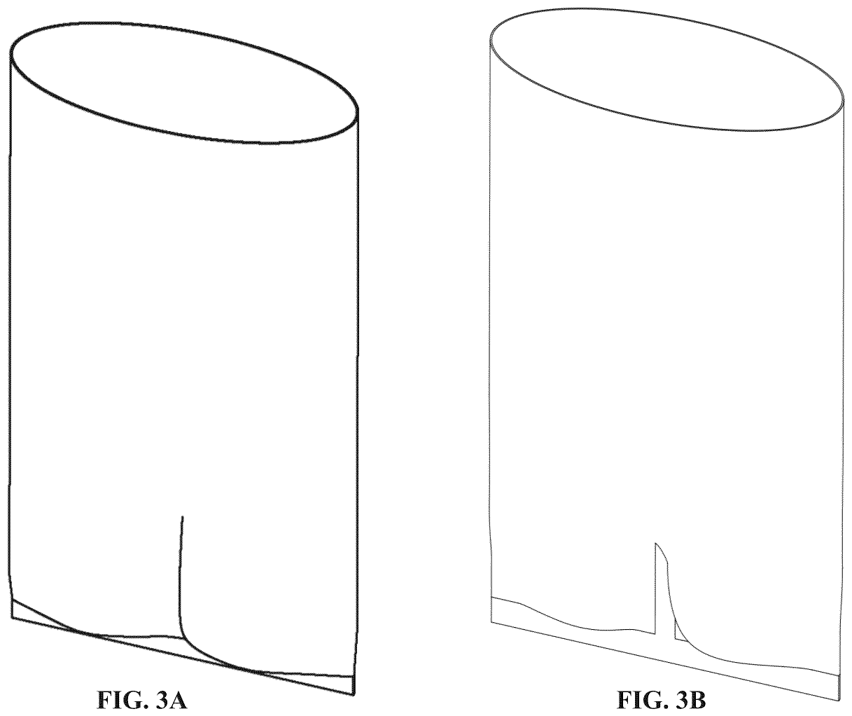

FIGS. 3A-3B are diagrams illustrating side views of the flat bags in accordance with some example embodiments of the waste collection bags of the instant application. This view offers insight into the bag's thin profile, emphasizing the sealed areas that form the finger compartments, that may provide for the bag's functionality and grip.

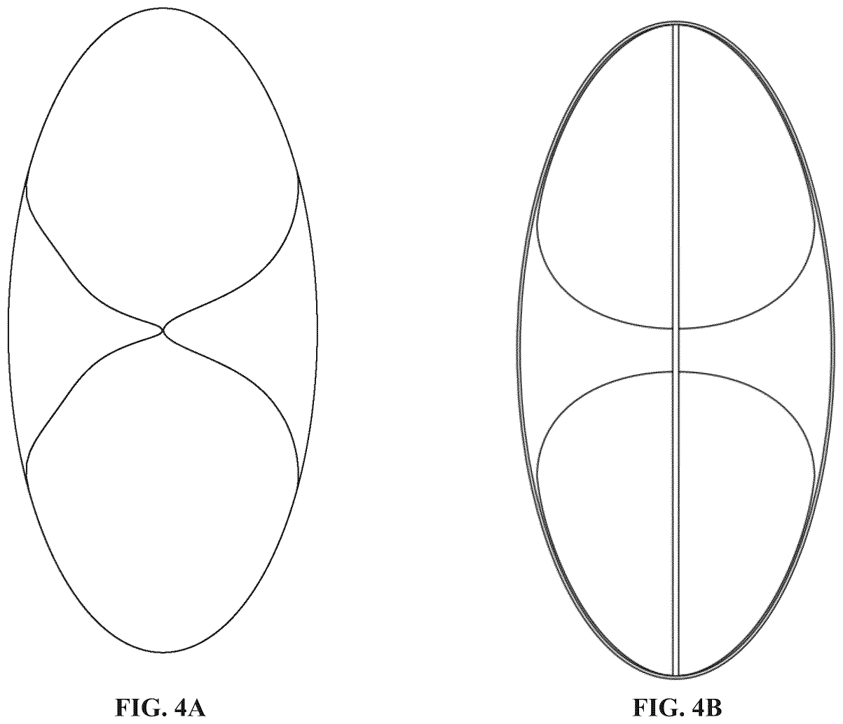

FIGS. 4A-4B are diagrams illustrating top views of the flat bags in accordance with some example embodiments of the waste collection bags of the instant application. The top view focuses on the bag's opening, also illustrating how the internal compartmentalization that may facilitate easy access and efficient waste collection.

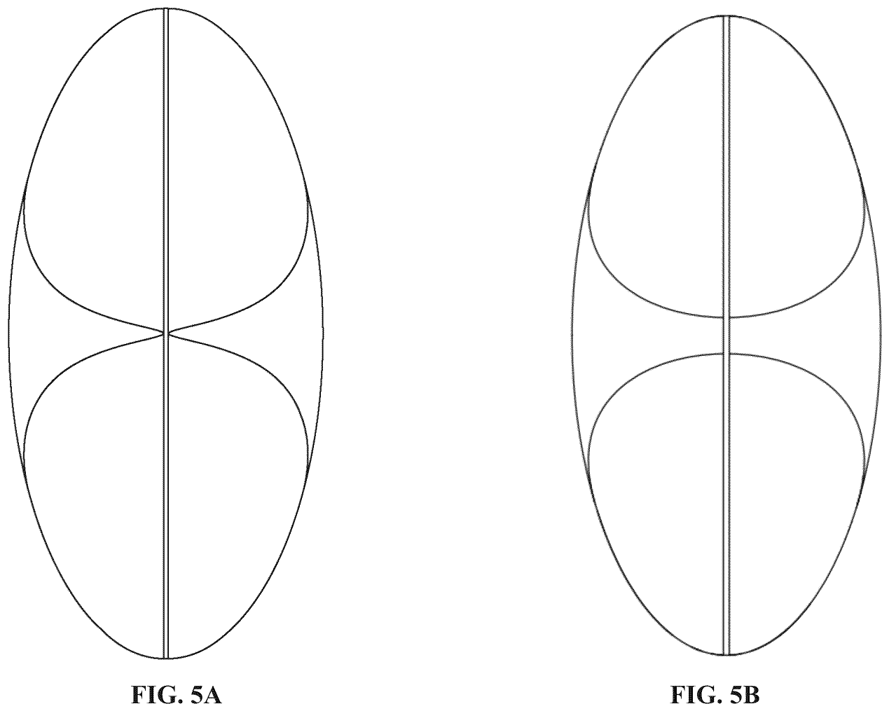

FIGS. 5A-5B are diagrams illustrating bottom views of the flat bags in accordance with some example embodiments of the waste collection bags of the instant application. The diagrams of FIGS. 5A-5B illustrate the sealed bottom edge, as well as internal aspects of the bags such as the internal compartmentalization that may facilitate easy access and efficient waste collection; e.g., the bags may be clear plastic allowing the internal features to be seen. The view in FIGS. 5A-5B provides perspective on how the bottom design contributes to the bag's overall functionality and secure waste containment.

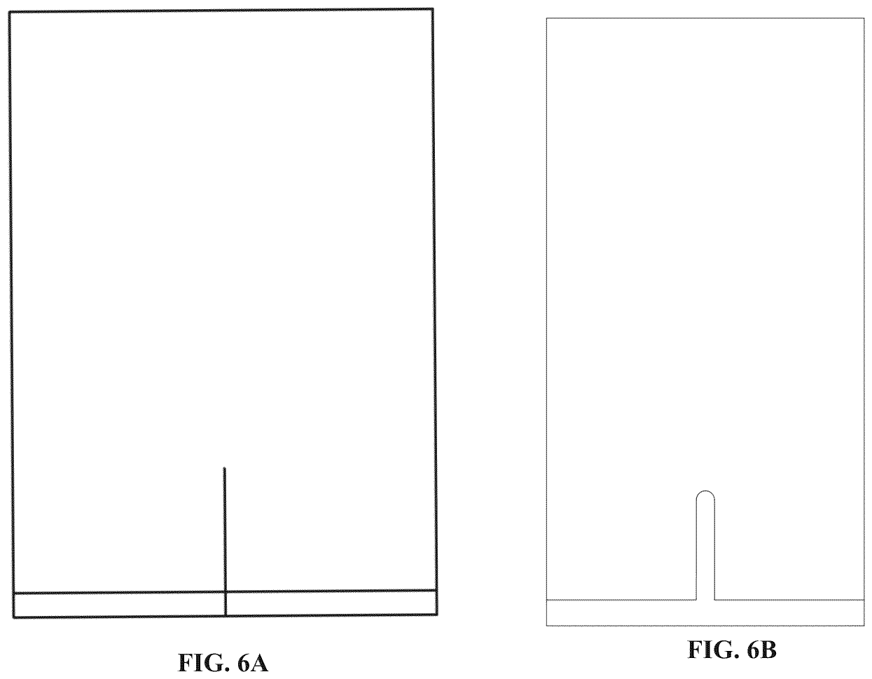

FIGS. 6A-6B are diagrams illustrating dorsal views of the flat bags in accordance with some example embodiments of the waste collection bags of the instant application. This illustrates the back side of the example bags, emphasizing any design features or structural elements that contribute to the bag's functionality, including how it enhances grip and user experience.

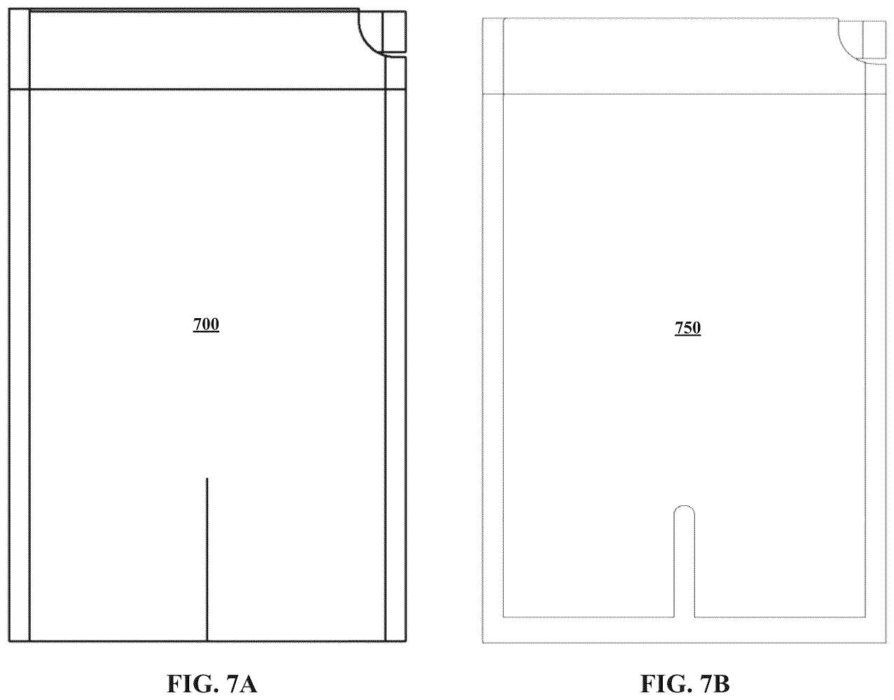

### FIGS. 7A-7B to 12A-12B: Embodiment with One Side Drawstring

FIGS. 7A-7B are diagrams illustrating main views of bags 700, 750 with a one-side drawstring in accordance with some example embodiments of the waste collection bags of the instant application. FIGS. 7A-7B introduce the inclusion of a drawstring closure system around the bag's opening, highlighting how this design provides a secure seal and enhances the bag's utility for pet waste collection and disposal.

The waste collection bags of FIGS. 7A-7B also include the innovative structure of FIGS. 1A and/or 1B, which may be designed specifically for pet waste management, as discussed above. The illustrated waste bags have a main body with an opening at one end for waste collection. The internal compartments may be designed to accommodate each finger separately and set these waste collection bags apart, enhancing the user's ability to grip and manipulate the bags precisely. These finger compartments are created by sealed areas that extend partway up from the bags' closed edge opposite the opening. This design focuses on improving the handling and control during waste collection, offering a simple, practical approach to maintaining hygiene and efficiency in pet waste disposal. The waste collection bags of FIGS. 7A-7B include a drawstring closure system around the bags' opening. The design of bag 700 features a central line in the middle of the bag. In contrast, the design of bag 750 may be stronger and less prone to tearing. Bag 150 may incorporate a U-shaped structure that redistributes tension when stretched, significantly enhancing durability and resistance to tearing

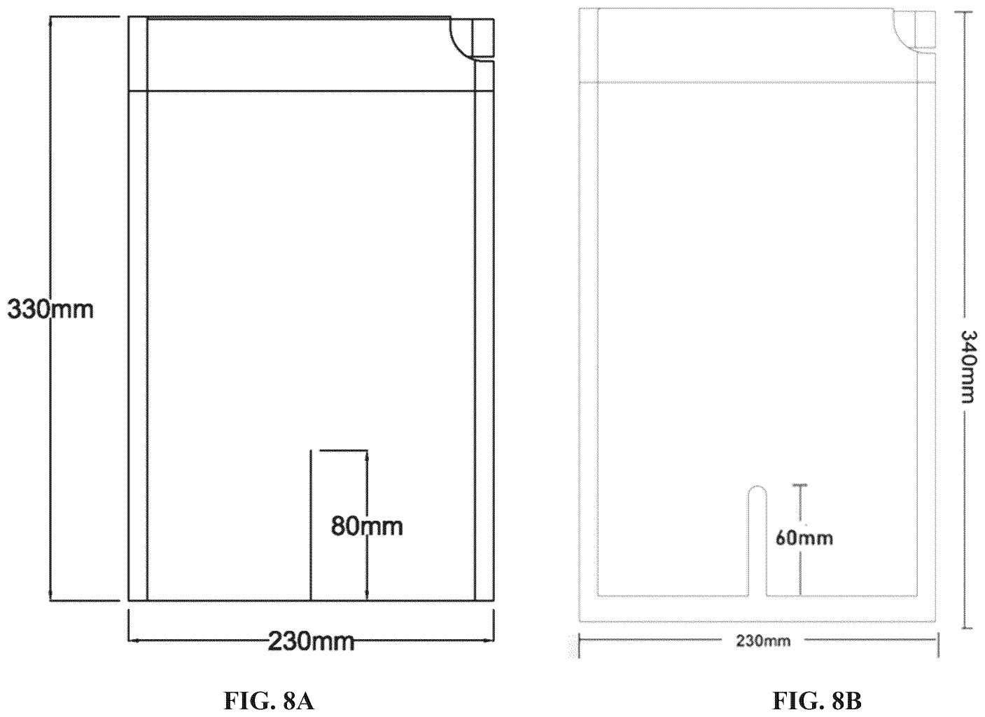

FIGS. 8A-8B are diagrams illustrating the main views of the bags with one side drawstring with example measurements in accordance with the waste collection bags of the instant application. This figure details the bag's dimensions and the drawstring length, emphasizing the functionality and convenience the drawstring adds to the waste collection process.

As discussed above with respect to FIGS. 2A-2B, recognizing that hand sizes vary significantly across individuals, the design of FIGS. 8A-8B, respectively, may include adaptability, which is a feature that may allow for the creation of multiple versions of the bags, each differing in dimensions. This flexibility ensures that users can find a bag that comfortably fits their hand, enabling efficient and hygienic waste collection without compromising on ease of use or control. By offering a variety of sizes, the design may cater to the ergonomic needs of different users, ensuring that the act of pet waste collection is as comfortable and effective as possible for everyone, or at least many different users.

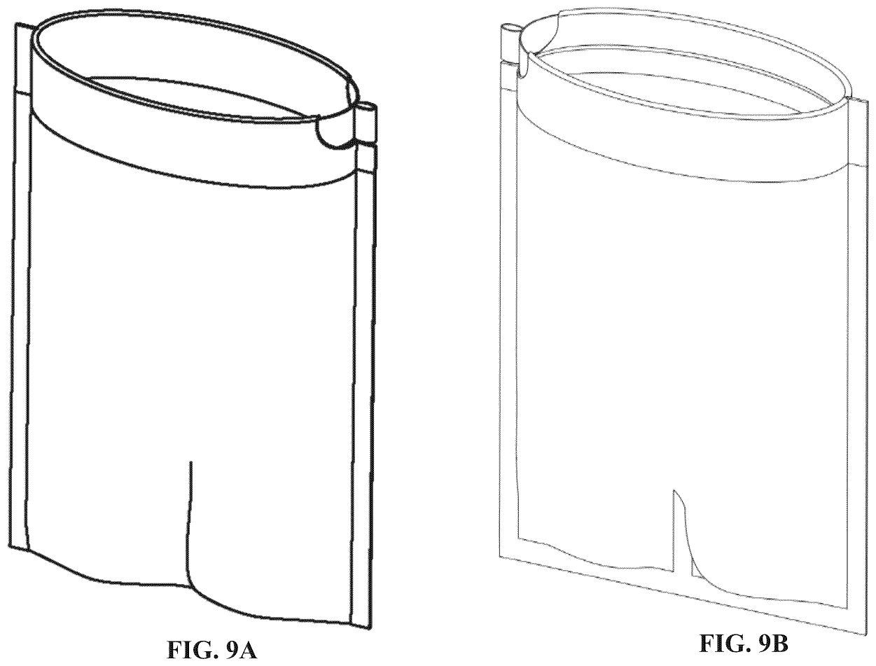

FIGS. 9A-9B are diagrams illustrating a side view of the bags with one side drawstring in accordance with some example embodiments of the waste collection bags of the instant application. The figures illustrate how the drawstring mechanism affects the bag's profile, underlining the ease of closing and sealing the bags after use.

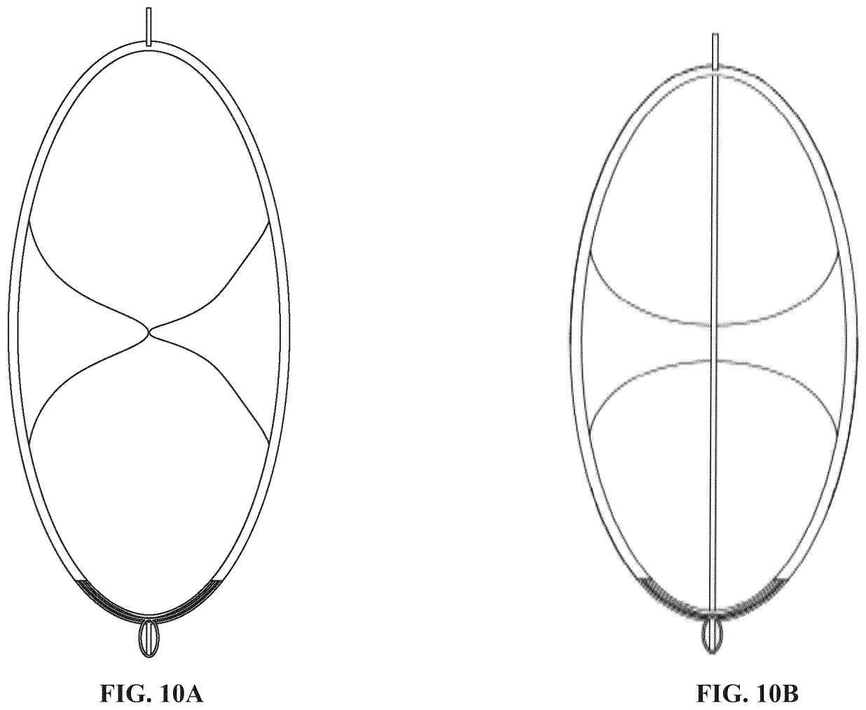

FIGS. 10A-10B are diagrams illustrating top views of the bags with one side drawstring in accordance with Some example embodiments of the waste collection bags of the instant application. This view focuses on how the drawstring facilitates carrying the bags to a disposal point, making waste collection more convenient.

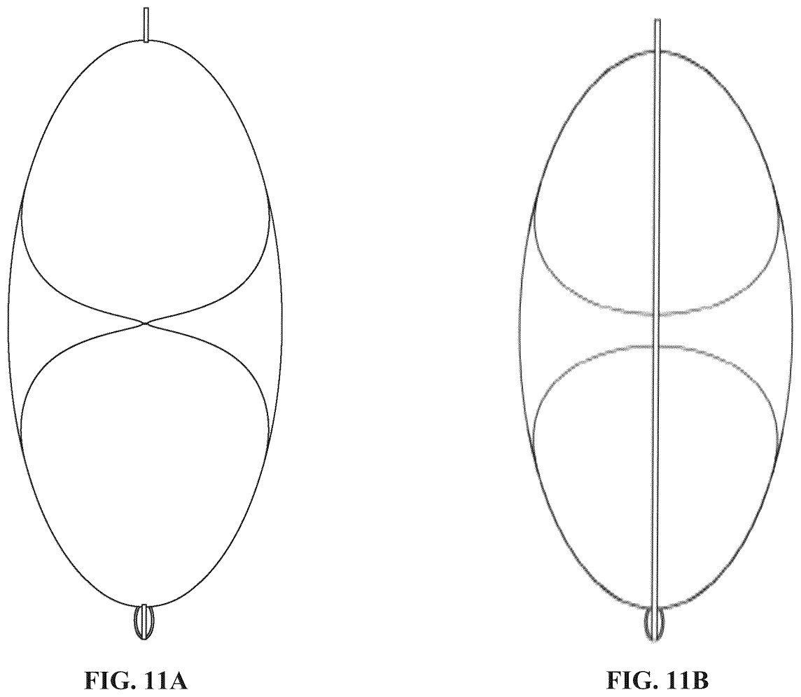

FIGS. 11A-11B are diagrams illustrating bottom views of the bags in accordance with some example embodiments of the waste collection bags of the instant application. The diagram of FIGS. 11A-11B illustrates the sealed bottom edge, as well as internal aspects of the bag such as the internal compartmentalization that may facilitate easy access and efficient waste collection, e.g., the bags may be clear plastic allowing the internal features to be seen. The view in FIGS. 11A-11B provides perspective on how the bottom design contributes to the bag's overall functionality and secure waste containment.

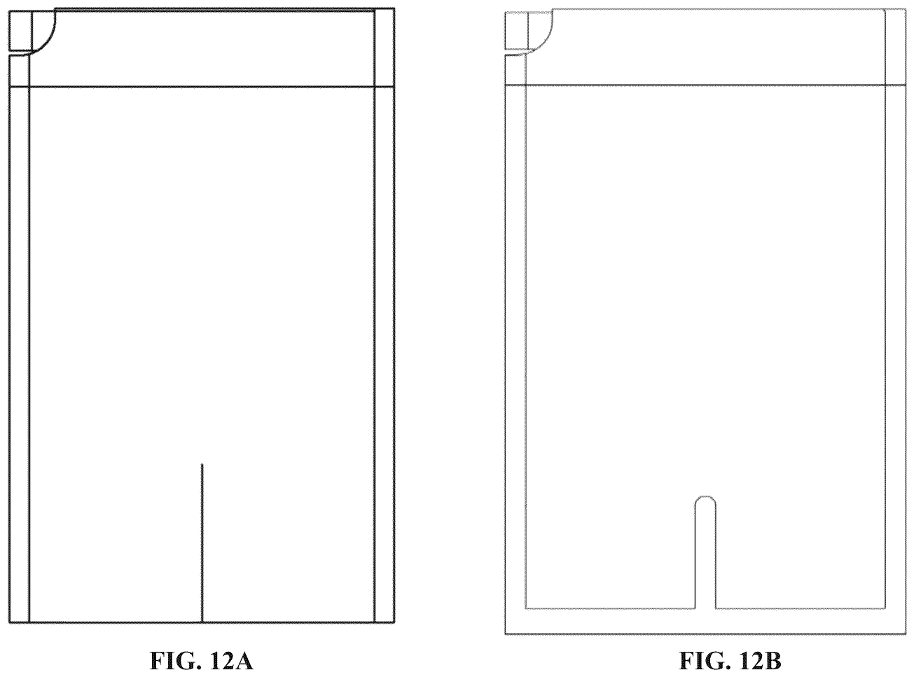

FIGS. 12A-12B are diagrams illustrating dorsal views of the bags with one side drawstring in accordance with some example embodiments of the waste collection bags of the instant application. This illustrates the backside features with the drawstring in place, emphasizing the drawstring's role in enhancing the bags' practicality for pet waste management.

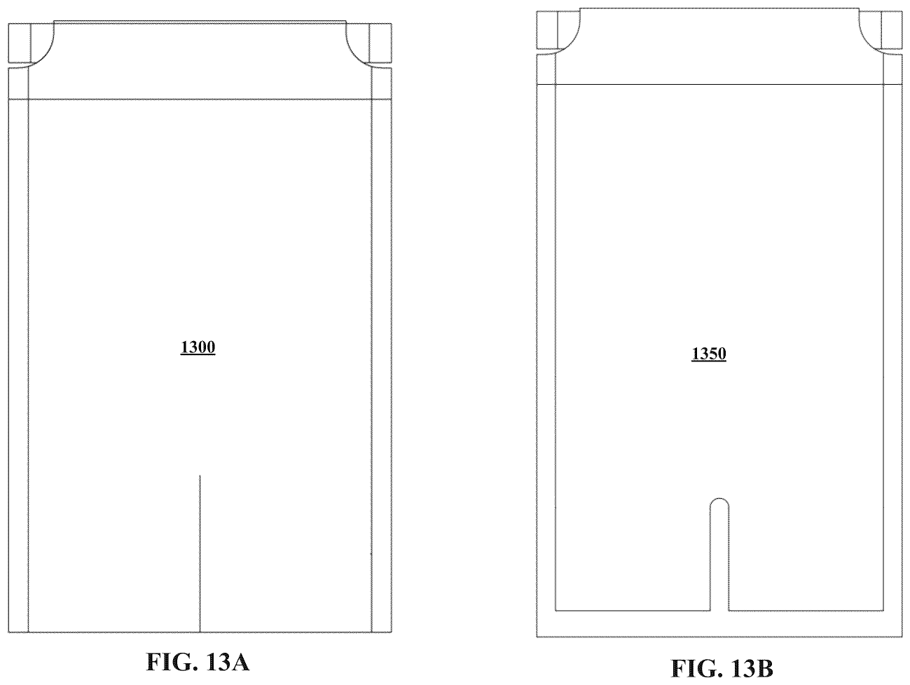

### FIGS. 13A-13B to 18A-18B: Embodiment with Two Side Drawstrings

FIGS. 13A-13B are diagrams illustrating main views of bags 1300, 1350 with two side drawstrings in accordance with some example embodiments of the waste collection bags of the instant application. This introduces an advanced design where two side drawstrings enhance the bag's sealing and carrying capabilities, illustrating a sophisticated approach to pet waste disposal that prioritizes user convenience and security.

The waste collection bags of FIGS. 13A-13B also includes the innovative structure of FIGS. 1A-1B and 7A-7B, which may be designed specifically for pet waste management as discussed above. The illustrated waste bags have a main body with an opening at one end for waste collection. The internal compartments may be designed to accommodate each finger separately and set these waste collection bags apart, enhancing the user's ability to grip and manipulate the bag precisely. These finger compartments are created by sealed areas that extend partway up from the bag's closed edge opposite the opening. These designs focus on improving the handling and control during waste collection, offering a simple, practical approach to maintaining hygiene and efficiency in pet waste disposal. The waste collection bags of FIGS. 7A-7B include a drawstring closure system around the bags' opening. The design of bag 1300 features a central line in the middle of the bag. In contrast, the design of bag 150 may be stronger and less prone to tearing. Bag 1350 may incorporate a U-shaped structure that redistributes tension when stretched, significantly enhancing durability and resistance to tearing

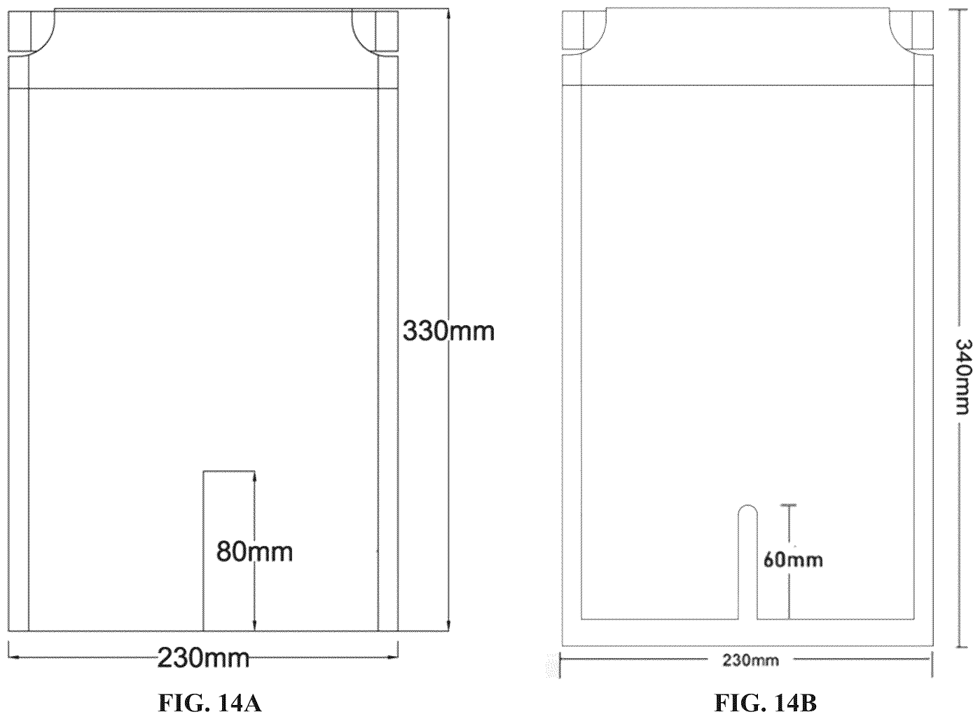

FIGS. 14A-14B are diagrams illustrating main views of the bags with two side drawstrings with example measurements in accordance with some example embodiments of the waste collection bags of the instant application. These figures provide detailed dimensions for the bag, including the placement and functionality of two drawstrings.

As discussed above with respect to FIGS. 2A-2B and 8A-8B, recognizing that hand sizes vary significantly across individuals, the designs of FIGS. 8A-8B include adaptability, which is a feature that may allow for the creation of multiple versions of the bag, each differing in dimensions. This flexibility may help ensure that users can find a bag that comfortably fits their hand, enabling efficient and hygienic waste collection without compromising on ease of use or control.

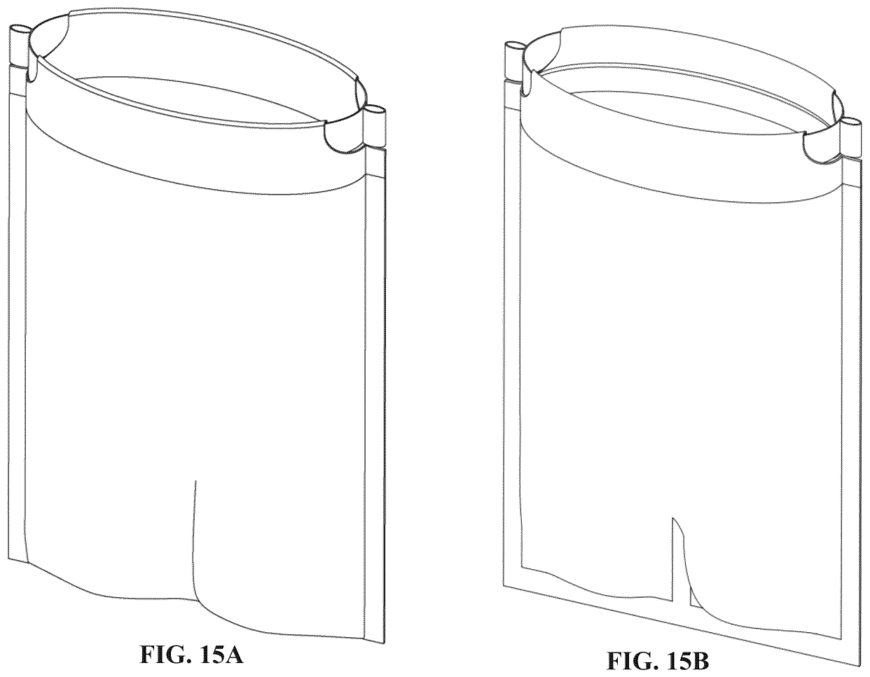

FIGS. 15A-15B are diagrams illustrating a side view of the bags with two side drawstrings in accordance with some example embodiments of the waste collection bags of the instant application. These views highlight the functionality of having two drawstrings, illustrating how they contribute to a more versatile and secure sealing mechanism. The side views allows us to appreciate the dual drawstring design's impact on the bags' usability, facilitating easier closure and enhancing the bags' overall practicality for pet waste collection.

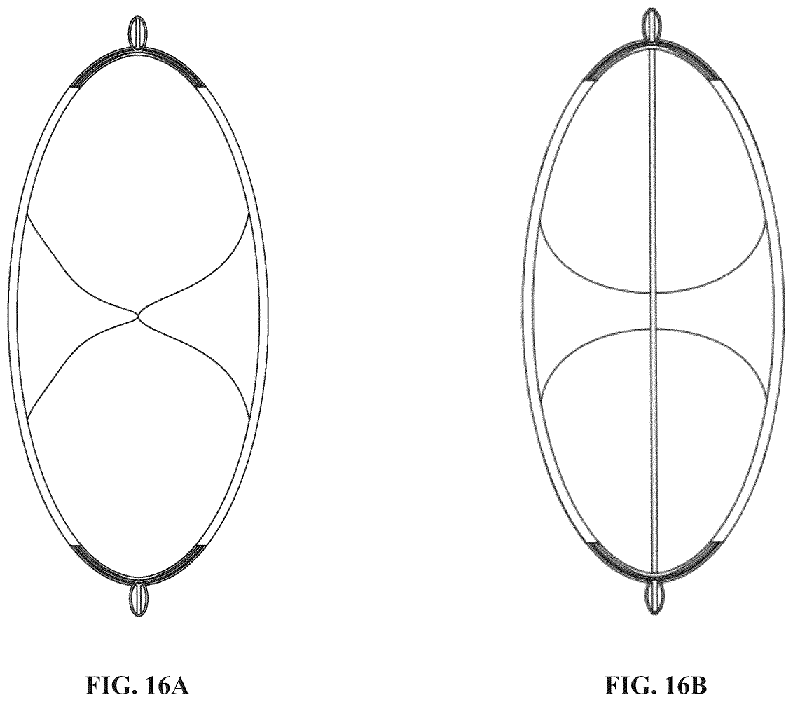

FIGS. 16A-16B are diagrams illustrating top views of the bags with two side drawstrings in accordance with some example embodiments of the waste collection bags of the instant application. From this perspective, the top views demonstrate how the two drawstrings are integrated around the bags' opening. This not only improves the ease of sealing and carrying the bag but also ensures that users can effectively manage pet waste with increased control and convenience, minimizing spillage and odor escape.

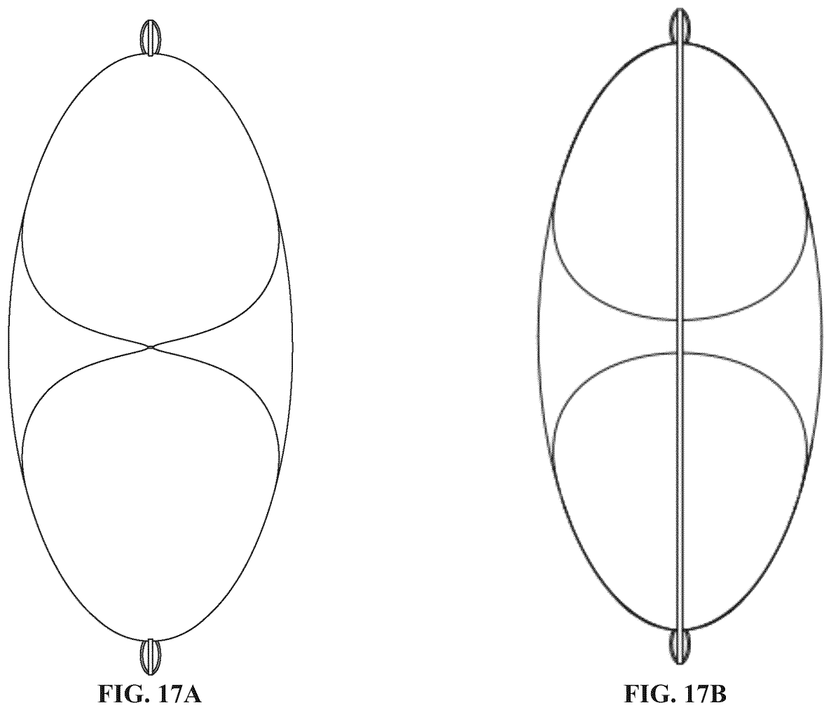

FIGS. 17A-17B is a diagram illustrating bottom views of the bags with two side drawstrings in accordance with some example embodiments of the waste collection bags of the instant application. The bottom views may reveal how the presence of two drawstrings affects the bag's design from below, potentially offering insights into how this feature enhances the structural integrity and functionality of the bag. This could include details on how the drawstrings contribute to the bag's ability to securely contain pet waste until it can be properly disposed of, thereby aligning with the goals of sanitation and efficiency.

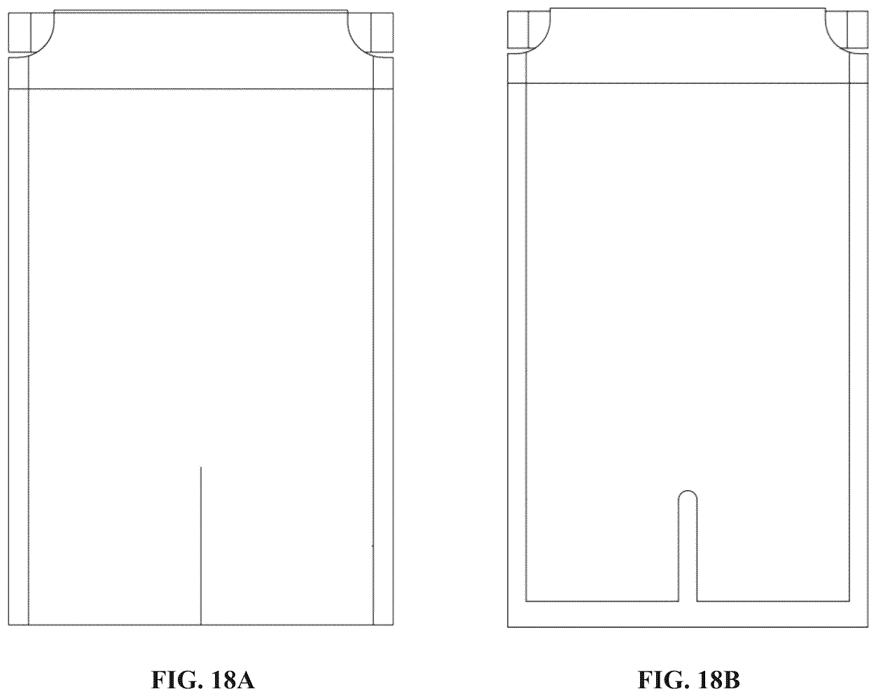

FIGS. 18A-18B are diagrams illustrating dorsal view of the bags with two side drawstrings in accordance with the waste collection bags of the instant application. These dorsal views allow us to see the back side of the bag, focusing on how the two drawstrings integrate with the bag's overall design. It might highlight the ergonomic consideration of the drawstrings, ensuring that they do not only function effectively for sealing and carrying but also blend seamlessly with the bag's aesthetic and functional design elements, further emphasizing the innovation and thoughtfulness behind this pet waste collection solution.

The waste collection bags described offer a significant improvement over traditional plastic bags for several reasons, especially in terms of usability and efficiency in picking up dog waste. Firstly, the design with a plurality of compartments for individual fingers dramatically enhances grip and control. This allows for more precise manipulation of the bag, making it easier to pick up waste from various surfaces and in different environmental conditions. The separate finger areas ensure that the user can apply a more targeted pressure and movement, reducing the likelihood of spillage or incomplete collection.

Additionally, the sealed area extending partway up from the closed edge opposite of the opening helps maintain the structural integrity of the bag, ensuring that each compartment is securely enclosed and that the waste is safely contained once collected. This design feature minimizes the risk of tears or breaches in the bag, which can be a common issue with standard plastic bags, especially when dealing with sharp or rough waste materials.

Furthermore, this innovative design could potentially offer a more hygienic and tactilely comfortable experience for the user, as it reduces direct contact with the waste by providing a more controlled and distanced handling. By enhancing the user's ability to effectively collect waste without fear of the bag ripping or losing grip, this bag represents a significant step forward in pet waste management solutions.

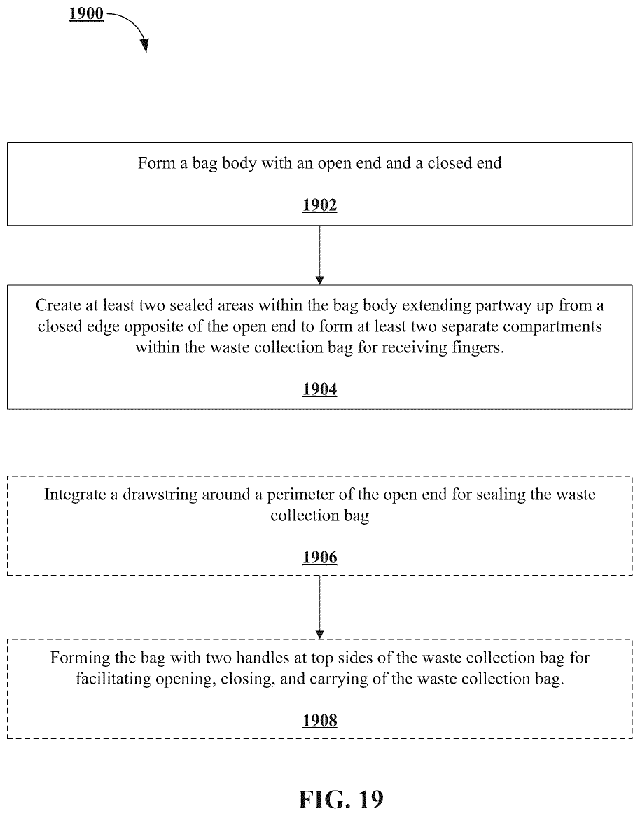

FIG. 19 is a flow diagram illustrating an example method 1900 of manufacturing a waste collection bag, in accordance with the systems and methods described herein. The method 1900 includes forming a bag body with an open end and a closed end (1902). The method 1900 also includes creating at least two sealed areas within the bag body extending partway up from a closed edge opposite the open end to form at least two separate compartments within the waste collection bag for receiving fingers (1904). Optionally, the method 1900 may further include integrating a drawstring (or two draw strings) around a perimeter of the open end for sealing the waste collection bag (1906). Optionally, the method 1900 may further include forming the bag with two handles at top sides of the waste collection bag for facilitating opening, closing, and carrying of the waste collection bag (1908).

As discussed above, the method 1900 includes forming a bag body with an open end and a closed end (1902). The initial step in manufacturing a waste collection bag involves forming the bag body, which includes an open end for inserting waste and a closed end to contain the waste. This foundational process sets the structural basis for the bag, determining its overall size and shape. The material selection, whether biodegradable, compostable, or traditional plastic, may also be decided at this stage, ensuring that the bag meets specific environmental and/or durability requirements.

The method 1900 also includes creating at least two sealed areas within the bag body extending partway up from a closed edge opposite the open end to form at least two separate compartments within the waste collection bag for receiving fingers (1904). For example, following the formation of the bag body, the next step may involve creating at least two sealed areas within the bag body. These areas extend partway up from the closed edge opposite the open end, effectively forming separate compartments designed to accommodate the user's fingers. This innovative feature enhances the bag's functionality by improving grip and control, making it easier for users to pick up and handle pet waste. The process may use sealing techniques to ensure the compartments are securely formed without compromising the bag's integrity. It will be understood that some embodiments may have more than two compartments. For example, three compartments may be formed, four compartments may be formed, e.g., one for each finger, five compartments may be formed, e.g., one for each finger and one for the thumb. A thumb compartment may be formed off a side at right angles to the other compartments. It will be further understood that even more compartments may be formed to allow users flexibility in finger/thumb placement, e.g., to the middle or to one side, for example.

Optionally, the method 1900 may further include integrating a drawstring around a perimeter of the open end for sealing the waste collection bag (1906). The manufacturing process may include integrating a drawstring around the perimeter of the bag's open end. This addition allows for easy and secure sealing of the bag after waste collection, effectively containing the waste and any associated odors. The drawstring also enhances the bag's convenience, providing a simple mechanism for users to close the bag tightly with minimal effort. This step involves attaching the drawstring in a way that it remains durable and functional throughout the bag's use.

Optionally, the method 1900 may further include forming the bag with two handles at top sides of the waste collection bag for facilitating opening, closing, and carrying of the waste collection bag (1908). The manufacturing process may include the addition of two handles at the top sides of the waste collection bag. These handles facilitate easier opening, closing, and carrying of the bag, contributing to an overall more user-friendly design. The handles are designed to be sturdy, ensuring they can support the weight of the bag's contents without tearing. This step requires careful design and integration to make sure the handles are both practical and durable, enhancing the bag's utility for users.

These figures are provided to illustrate and explain the concepts of the invention. It should be noted that they are not exhaustive and other configurations and embodiments are possible within the scope of the invention.

One or more of the components, steps, features, and/or functions illustrated in the figures may be rearranged and/or combined into a single component, block, feature or function or embodied in several components, steps, or functions. Additional elements, components, steps, and/or functions may also be added without departing from the disclosure. The apparatus, devices, and/or components illustrated in the Figures may be configured to perform one or more of the methods, features, or steps described in the Figures. The algorithms described herein may also be efficiently implemented in software and/or embedded in hardware.

Reference in the specification to “one embodiment” or “an embodiment” means that a particular feature, structure, or characteristic described in connection with the embodiment is included in at least one embodiment of the invention. The appearances of the phrase “in one embodiment” in various places in the specification are not necessarily all referring to the same embodiment.

Some portions of the detailed description are presented in terms of algorithms and symbolic representations of operations on data bits within a computer memory. These algorithmic descriptions and representations are the methods used by those skilled in the data processing arts to most effectively convey the substance of their work to others skilled in the art. An algorithm is here, and generally, conceived to be a self-consistent sequence of steps leading to a desired result. The steps are those requiring physical manipulations of physical quantities. Usually, though not necessarily, these quantities take the form of electrical or magnetic signals capable of being stored, transferred, combined, compared or otherwise manipulated. It has proven convenient at times, principally for reasons of common usage, to refer to these signals as bits, values, elements, symbols, characters, terms, numbers or the like.

It should be borne in mind, however, that all of these and similar terms are to be associated with the appropriate physical quantities and are merely convenient labels applied to these quantities. Unless specifically stated otherwise as apparent from the following disclosure, it is appreciated that throughout the disclosure terms such as “processing,” “computing,” “calculating,” “determining,” “displaying” or the like, refer to the action and processes of a computer system, or similar electronic computing device, that manipulates and transforms data represented as physical (electronic) quantities within the computer system's registers and memories into other data similarly represented as physical quantities within the computer system's memories or registers or other such information storage, transmission or display.

Finally, the algorithms and displays presented herein are not inherently related to any particular computer or other apparatus. Various general-purpose systems may be used with programs in accordance with the teachings herein, or it may prove convenient to construct more specialized apparatus to perform the required method steps. The required structure for a variety of these systems will appear from the description below. It will be appreciated that a variety of programming languages may be used to implement the teachings of the invention as described herein.

The foregoing description of the embodiments of the present invention has been presented for the purposes of illustration and description. It is not intended to be exhaustive or to limit the present invention to the precise form disclosed. Many modifications and variations are possible in light of the above teaching. It is intended that the scope of the present invention be limited not by this detailed description, but rather by the claims of this application. As will be understood by those familiar with the art, the present invention may be embodied in other specific forms without departing from the spirit or essential characteristics thereof. Likewise, the particular naming and division of the modules, routines, features, attributes, methodologies and other aspects are not mandatory or significant, and the mechanisms that implement the present invention or its features may have different names, divisions and/or formats.

Furthermore, as will be apparent to one of ordinary skill in the relevant art, the modules, routines, features, attributes, methodologies and other aspects of the present invention can be implemented as software, hardware, firmware or any combination of the three. Also, wherever a component, an example of which is a module, of the present invention is implemented as software, the component can be implemented as a standalone program, as part of a larger program, as a plurality of separate programs, as a statically or dynamically linked library, as a kernel loadable module, as a device driver, and/or in every and any other way known now or in the future to those of ordinary skill in the art of computer programming.

Additionally, the present invention is in no way limited to implementation in any specific programming language, or for any specific operating system or environment. Accordingly, the disclosure of the present invention is intended to be illustrative, but not limiting, of the scope of the present invention, which is set forth in the following claims.

It is understood that the specific order or hierarchy of blocks in the processes/flowcharts disclosed is an illustration of example approaches. Based upon design preferences, it is understood that the specific order or hierarchy of blocks in the processes/flowcharts may be rearranged. Further, some blocks may be combined or omitted. The accompanying method claims present elements of the various blocks in a sample order and are not meant to be limited to the specific order or hierarchy presented.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but is to be accorded the full scope consistent with the language claims, wherein reference to an element in the singular is not intended to mean “one and only one” unless specifically so stated, but rather “one or more.” The word “exemplary” is used herein to mean “serving as an example, instance, or illustration.” Any aspect described herein as “exemplary” is not necessarily to be construed as preferred or advantageous over other aspects. Unless specifically stated otherwise, the term “some” refers to one or more. Combinations such as “at least one of A, B, or C,” “one or more of A, B, or C,” “at least one of A, B, and C,” “one or more of A, B, and C,” and “A, B, C, or any combination thereof” include any combination of A, B, and/or C, and may include multiples of A, multiples of B, or multiples of C. Specifically, combinations such as “at least one of A, B, or C,” “one or more of A, B, or C,” “at least one of A, B, and C,” “one or more of A, B, and C,” and “A, B, C, or any combination thereof” may be A only, B only, C only, A and B, A and C, B and C, or A and B and C, where any such combinations may contain one or more member or members of A, B, or C. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. The words “module,” “mechanism,” “element,” “device,” and the like may not be a substitute for the word “means.” As such, no claim element is to be construed as a means plus function unless the element is expressly recited using the phrase “means for.”

What is claimed is:

1. A waste collection bag comprising:
a body having an opening at one end; and
a plurality of compartments formed within said body, each compartment being sized and shaped to receive a user's finger, thereby defining separate finger areas within the waste collection bag to facilitate gripping and manipulation of the waste collection bag,
wherein said compartments are formed by a sealed area extending partway up from a closed edge opposite of the opening.

2. The waste collection bag of claim 1, wherein a material of the body comprises one or more of: polyethylene, polypropylene, polylactic acid (PLA), polyhydroxyalkanoates (PHAs), corn starch-based compounds, or recycled materials.

3. The waste collection bag of claim 1, further comprising a drawstring integrated around a perimeter of the opening for sealing the waste collection bag after use.

4. The waste collection bag of claim 3, wherein the drawstring, when tightened, forms a handle for carrying the waste collection bag.

5. The waste collection bag of claim 1, further comprising two handles located at top sides of the waste collection bag configured to facilitate the opening, closing, and carrying of the waste collection bag.

6. The waste collection bag of claim 5, wherein the two handles can be tied together to seal the waste collection bag after use.

7. The waste collection bag of claim 1, wherein the waste collection bag is biodegradable and is made from materials that decompose under composting conditions.

8. A method of manufacturing a waste collection bag, the method comprising:
forming a bag body with an open end and a closed end; and
creating at least two sealed areas within the bag body extending partway up from a closed edge opposite of the open end to form at least two separate compartments within the waste collection bag for receiving fingers.

9. The method of claim 8, further comprising integrating a drawstring around a perimeter of the open end for sealing the waste collection bag.

10. The method of claim 8, further comprising forming the bag with two handles at top sides of the waste collection bag for facilitating opening, closing, and carrying of the waste collection bag.

11. The method of claim 8, wherein the waste collection bag is manufactured using materials selected from the group consisting of polyethylene, polypropylene, polylactic acid (PLA), polyhydroxyalkanoates (PHAs), corn starch-based compounds, and recycled materials.
